(19) United States
(12) Patent Application Publication
(10) Pub. No.: US 2005/0060583 A1
(43) Pub. Date: Mar. 17, 2005

(54) System and method for advanced intrusion avoidance

(76) Inventor: Jeou-Kai Lin, Campgell, CA (US)

Correspondence Address: FORTUNE LAW GROUP, 100 Century Center Ct., San Jose, CA, 95112, US

(21) Appl. No.: 10/890,923

(22) Filed: Jul. 14, 2004

Related U.S. Application Data
(60) Provisional application No. 60/487,445, filed on Jul. 15, 2003.

(51) Int. Cl. G06F 11/30; G06F 15/173

(52) U.S. Cl. 713/201; 709/224

(57) ABSTRACT

A method for providing front line defense against intrusion includes the steps of intercepting packets flowing into a machine from a NIC, passing the intercepted packets to a front line advanced intrusion avoidance engine for analysis, passing, cleaning, rejecting or deleting the intercepted packets based upon the front line advanced intrusion avoidance engine's analysis, performing socket layer functions on passed and cleaned packets, intercepting packets passed to a socket layer, passing the intercepted packets to the front line advanced intrusion avoidance engine for application layer security analysis, and passing the packets which pass the application layer security analysis to an application from a socket system call.

### CROSS REFERENCE TO RELATED APPLICATIONS

The present application claims priority under 35 U.S.C. 119(e) from provisional patent application Ser. No. 60/487,445, entitled “System and Method for Advanced Intrusion Avoidance”, filed on Jul. 15, 2003, the disclosure of which is herein incorporated by reference in its entirety.

### BACKGROUND OF THE INVENTION

The present invention generally relates to network security and more particularly to a system and method for advanced intrusion avoidance.

It is well know that Internet sites are vulnerable to attack from all over the world. Furthermore, as wireless technology becomes more prevalent, the nature of these attacks becomes more severe.

Prior art systems and methods for detecting intrusion include looking at the data stream in the NIC and IP layer, embedding intrusion detecting capabilities in applications and scanning files when reading or writing them.

None of these prior art systems are effective against intrusion such as is now prevalent. As such there is a need for a smarter and stricter system and method capable of protecting end hosts which affords greater network performance, security accuracy and security efficiency.

### SUMMARY OF THE INVENTION

In accordance with one aspect of the invention, a method for providing front line defense against intrusion includes the steps of intercepting packets flowing into a machine from a NIC, passing the intercepted packets to a front line advanced intrusion avoidance engine for analysis, passing, cleaning, rejecting or deleting the intercepted packets based upon the front line advanced intrusion avoidance engine's analysis, performing socket layer functions on passed and cleaned packets, intercepting packets passed to a socket layer, passing the intercepted packets to the front line advanced intrusion avoidance engine for application layer security analysis, and passing the packets which pass the application layer security analysis to an application from a socket system call.

In accordance with another aspect of the invention, a system for providing front line defense against intrusion includes a memory comprising program instructions, and a processor coupled to the memory, the processor operable to execute the program instructions to perform the operations of intercepting packets flowing into a machine from a NIC, passing the intercepted packets to a front line advanced intrusion avoidance engine for analysis, passing, cleaning, rejecting or deleting the intercepted packets based upon the front line advanced intrusion avoidance engine's analysis, performing socket layer functions on passed and cleaned packets, intercepting packets passed to a socket layer, passing the intercepted packets to the front line advanced intrusion avoidance engine for application layer security analysis, and passing the packets which pass the application layer security analysis to an application from a socket system call.

In accordance with yet another aspect of the invention, a computer-readable medium containing one or more instructions providing front line defense against intrusion includes a code segment for intercepting packets flowing into a machine from a NIC, a code segment for passing the intercepted packets to a front line advanced intrusion avoidance engine for analysis, a code segment for passing, cleaning, rejecting or deleting the intercepted packets based upon the front line advanced intrusion avoidance engine's analysis, a code segment for performing socket layer functions on passed and cleaned packets, a code segment for intercepting packets passed to a socket layer, a code segment for passing the intercepted packets to the front line advanced intrusion avoidance engine for application layer security analysis, and a code segment for passing the packets which pass the application layer security analysis to an application from a socket system call.

In accordance with another aspect of the invention, a method for providing back line defense against intrusion includes the steps of accessing a file by a user process, making a file system call, passing the file to a back line advanced intrusion avoidance engine, analyzing the file in the back line advanced intrusion avoidance engine, performing file entries and Vnode operations on an analyzed file, passing the file to the back line advanced intrusion avoidance engine, analyzing the file in the back line advanced intrusion avoidance engine, performing Inode operations on an analyzed file, and calling a device driver.

In accordance with another aspect of the invention, a system for providing back line defense against intrusion includes a memory comprising program instructions, and a processor coupled to the memory, the processor operable to execute the program instructions to perform the operations of accessing a file by a user process, making a file system call, passing the file to a back line advanced intrusion avoidance engine, analyzing the file in the back line advanced intrusion avoidance engine, performing file entries and Vnode operations on an analyzed file, passing the file to the back line advanced intrusion avoidance engine, analyzing the file in the back line advanced intrusion avoidance engine, performing Inode operations on an analyzed file, and calling a device driver.

In accordance with yet another aspect of the invention, a computer-readable medium containing one or more instructions providing back line defense against intrusion includes a code segment for accessing a file by a user process, a code segment for making a file system call, a code segment for passing the file to a back line advanced intrusion avoidance engine, a code segment for analyzing the file in the back line advanced intrusion avoidance engine, a code segment for performing file entries and Vnode operations on an analyzed file, a code segment for passing the file to the back line advanced intrusion avoidance engine, a code segment for analyzing the file in the back line advanced intrusion avoidance engine, a code segment for performing Inode operations on an analyzed file, and a code segment for calling a device driver.

These and other features, aspects and advantages of the present invention will become better understood with reference to the following drawings, description and claims.

### BRIEF DESCRIPTION OF THE DRAWINGS

FIG. 1 is a flow diagram of a front line method in accordance with the present invention;

FIG. 2 is a flow diagram of a back line method in accordance with the present invention; and

FIG. 3 is a schematic representation of a system in accordance with the present invention.

### DETAILED DESCRIPTION OF THE INVENTION

The following detailed description is of the best mode of carrying out the invention. The description is not to be taken in a limiting sense, but is made merely for the purpose of illustrating the general principles of the invention, since the scope of the invention is best defined by the appended claims.

The present invention generally provides a method for providing both front line and back line defense against intrusion including methods for front line defense and a back line defense.

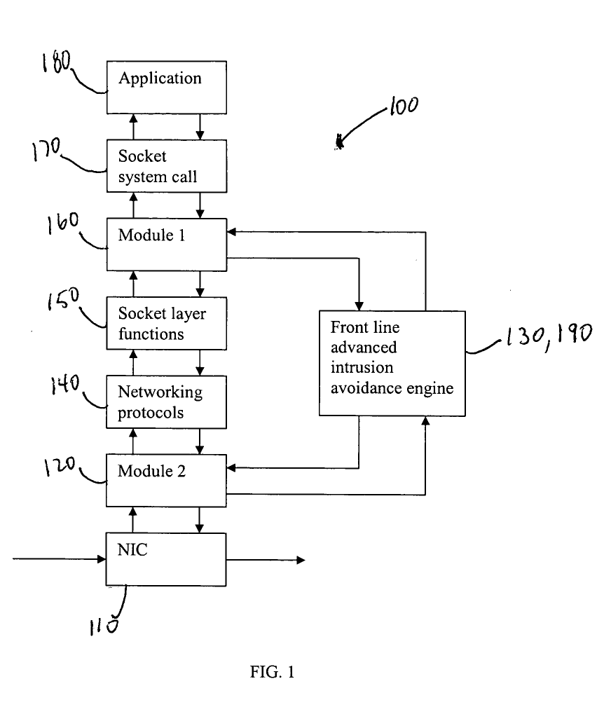

With reference to FIG. 1, a method for providing front line defense against intrusion generally designated 100 includes a step 110 in which data/packets may flow into a machine from a NIC. In a step 120, a first module (module 2) may intercept the data/packet and in a step 130 the data/packet may be passed to a front line advanced intrusion avoidance engine for analysis. The first module may pass, clean, reject, or delete the data/packet on a basis of an analysis performed by the front line advanced intrusion avoidance engine. If the data/packet is passed or cleaned, in steps 140 and 150 the data/packet may be passed to a socket layer. In a step 160 the data/packet may be intercepted by a second module (module 1) and in a step 190 the front line advanced intrusion avoidance engine may analyze the data/packet for application layer security. Finally, in steps 170 and 180 the data/packet which pass the application layer security analysis may be passed to an application from a socket system call. Additional steps (not shown) may include state information analysis and coordination between module 1 and module 2 performed to safeguard data/packet transmission.

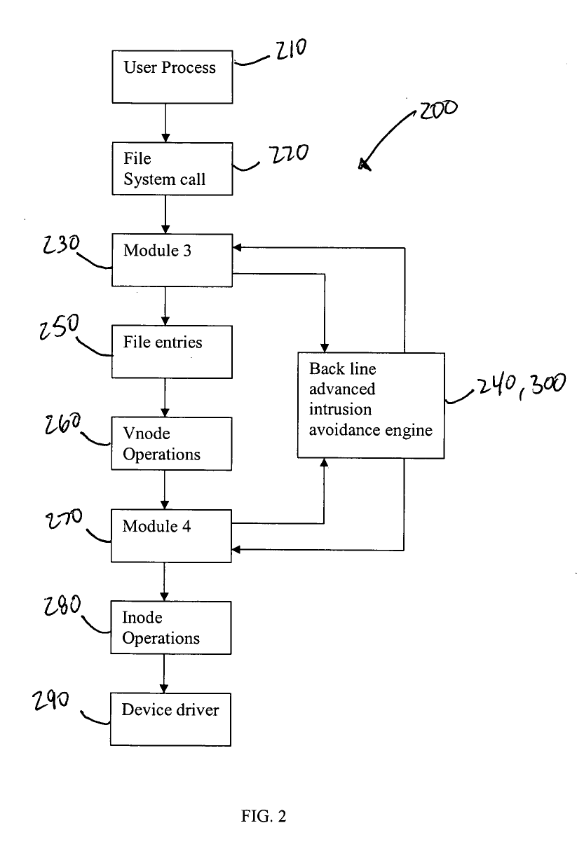

With reference to FIG. 2, a method for providing back line defense against intrusion generally designated 200 includes a step 210 in which a user process may access a file for reading and/or writing. In a step 220 a file system call may be made and in a step 230 a third module (module 3) may pass the file to a back line advanced intrusion avoidance engine. In a step 240, the back line advanced intrusion avoidance engine may analyze the file. In steps 250 and 260 file entries and Vnode operations may be performed respectively. In step 270 the file may be passed to the back line advanced intrusion avoidance engine where it may be analyzed in a step 300. In a step 280 Inode operations may be performed and in a step 290 a device driver may be called.

As will be appreciated by those skilled in the art, methods 100 and 200 can be combined to provide a method for providing both front line and back line defense against intrusion including method 100 for front line defense and method 200 for back line defense.

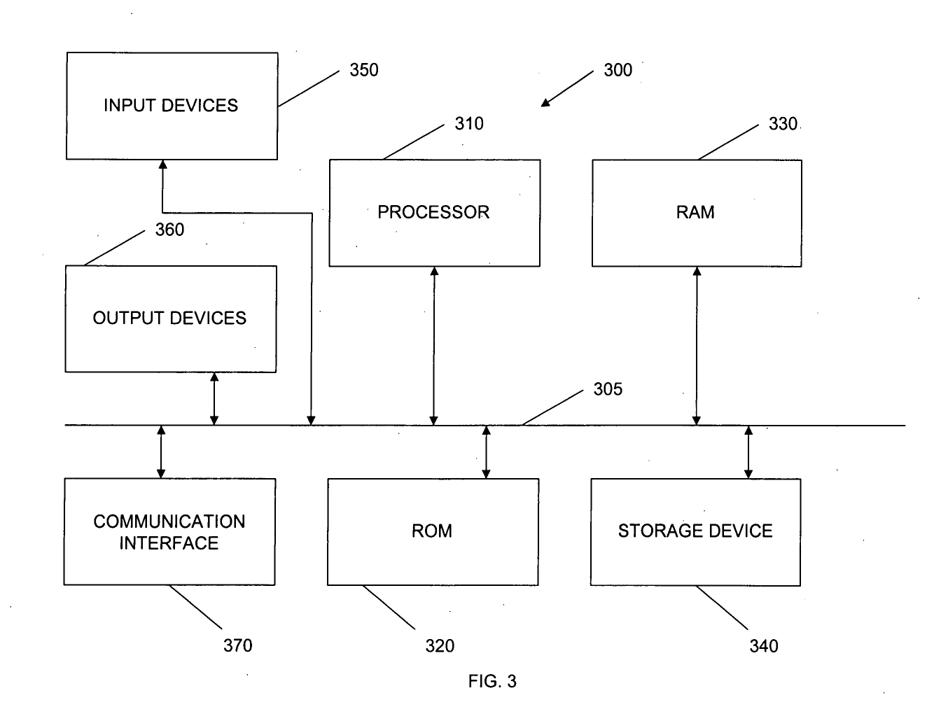

A system generally designated 300 shown in FIG. 3 may be operable to implement methods 100 and 200. System 300 may include a processor 310 coupled to a bus 305. Processor 310 may be operable to execute instructions stored in a read only memory device 320 and a random access memory device 330 which may be coupled to bus 305. Instructions stored in read only memory device 320 and random access memory device 330 may be operable to implement methods 100 and 200. System 300 may further include a storage device 340, input devices 350, output devices 360, and communication interface 370 coupled to bus 305.

In another aspect of the invention, a computer readable medium may be operable to store computer readable code operable to implement methods 100 and 200. Code segments stored in computer readable medium may be operable to instruct processor 310 to implement methods 100 and 200.

It should be understood, of course, that the foregoing relates to preferred embodiments of the invention and that modifications may be made without departing from the spirit and scope of the invention.

1. A method for providing front line defense against intrusion comprising the steps of:
intercepting packets flowing into a machine from a NIC;
passing the intercepted packets to a front line advanced intrusion avoidance engine for analysis;
passing, cleaning, rejecting or deleting the intercepted packets based upon the front line advanced intrusion avoidance engine's analysis;
performing socket layer functions on passed and cleaned packets;
intercepting packets passed to a socket layer;
passing the intercepted packets to the front line advanced intrusion avoidance engine for application layer security analysis; and
passing the packets which pass the application layer security analysis to an application from a socket system call.

2. A system for providing front line defense against intrusion comprising:
a memory comprising program instructions; and
a processor coupled to the memory, the processor operable to execute the program instructions to perform the operations of intercepting packets flowing into a machine from a NIC, passing the intercepted packets to a front line advanced intrusion avoidance engine for analysis, passing, cleaning, rejecting or deleting the intercepted packets based upon the front line advanced intrusion avoidance engine's analysis, performing socket layer functions on passed and cleaned packets, intercepting packets passed to a socket layer, passing the intercepted packets to the front line advanced intrusion avoidance engine for application layer security analysis, and passing the packets which pass the application layer security analysis to an application from a socket system call.

3. A computer-readable medium containing one or more instructions providing front line defense against intrusion comprising:
a code segment for intercepting packets flowing into a machine from a NIC;
a code segment for passing the intercepted packets to a front line advanced intrusion avoidance engine for analysis;
a code segment for passing, cleaning, rejecting or deleting the intercepted packets based upon the front line advanced intrusion avoidance engine's analysis;
a code segment for performing socket layer functions on passed and cleaned packets;
a code segment for intercepting packets passed to a socket layer;
a code segment for passing the intercepted packets to the front line advanced intrusion avoidance engine for application layer security analysis; and
a code segment for passing the packets which pass the application layer security analysis to an application from a socket system call.

4. A method for providing back line defense against intrusion comprising the steps of:
accessing a file by a user process;
making a file system call;
passing the file to a back line advanced intrusion avoidance engine;
analyzing the file in the back line advanced intrusion avoidance engine;
performing file entries and Vnode operations on an analyzed file;
passing the file to the back line advanced intrusion avoidance engine;
analyzing the file in the back line advanced intrusion avoidance engine;
performing Inode operations on an analyzed file; and
calling a device driver.

5. A system for providing back line defense against intrusion comprising:
a memory comprising program instructions; and
a processor coupled to the memory, the processor operable to execute the program instructions to perform the operations of accessing a file by a user process, making a file system call, passing the file to a back line advanced intrusion avoidance engine, analyzing the file in the back line advanced intrusion avoidance engine, performing file entries and Vnode operations on an analyzed file, passing the file to the back line advanced intrusion avoidance engine, analyzing the file in the back line advanced intrusion avoidance engine, performing Inode operations on an analyzed file, and calling a device driver.

6. A computer-readable medium containing one or more instructions providing back line defense against intrusion comprising:
a code segment for accessing a file by a user process;
a code segment for making a file system call;
a code segment for passing the file to a back line advanced intrusion avoidance engine;
a code segment for analyzing the file in the back line advanced intrusion avoidance engine;
a code segment for performing file entries and Vnode operations on an analyzed file;
a code segment for passing the file to the back line advanced intrusion avoidance engine;
a code segment for analyzing the file in the back line advanced intrusion avoidance engine;
a code segment for performing Inode operations on an analyzed file; and
a code segment for calling a device driver.
